(19) United States
(12) Patent Application Publication
(10) Pub. No.: US 2026/0170593 A1
(43) Pub. Date: Jun. 18, 2026

(54) OPTIMIZING FPGA RESOURCE UTILIZATION WITH DSP-BASED MASK OPERATORS

(71) Applicant: Microsoft Technology Licensing, LLC, Redmond, WA (US)

(72) Inventor: Michael MILKOV, Nahariyya (IL)

(21) Appl. No.: 18/984,970

(22) Filed: Dec. 17, 2024

(51) Int. Cl. G06T 1/20; G06T 15/80

(52) U.S. Cl. CPC G06T 1/20; G06T 15/80

(57) ABSTRACT

Optimization of field programmable gate array (FPGA) resource utilization using digital signal processor (DSP) blocks to implement a DSP-based mask operator is provided. A first vector is divided into a first n-bit subgroup and a second vector is divided into a second n-bit subgroup. A mask is applied to the first n-bit subgroup to generate a first masked vector and the mask is applied to the second n-bit subgroup to generate a second masked vector. The second masked vector is subtracted from the first masked vector to generate a result and the generated result is outputted. If a value of the result is zero, the first vector subgroup after applying the mask and the second vector subgroup after applying the mask are determined to be the same.

### BACKGROUND

Hardware accelerators are deployed on devices such as field programmable gate arrays (FPGAs). An FPGA is a hardware device that includes an array of logic blocks and reconfigurable interconnects between those logic blocks. In Intel® (or, formerly, Altera®) products, these logic blocks may be referred to as adaptive logic modules (ALMs) and in Xilinx® products, these may be referred to as configurable logic blocks (CLBs). Each logic block includes programmable logic, such as one or more look up tables (LUTs) for performing configurable logical mappings from inputs to outputs, an adder for adding input values, a register for temporarily holding data, and the like. However, when hardware designs excessively utilize ALMs/CLBs or other LUT-based logic blocks, it can present significant challenges in producing valid results.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system and method for optimizing field programmable gate array (FPGA) resource utilization with digital signal processor (DSP) blocks to implement a DSP-based mask operator are provided. A first vector is divided into a first n-bit subgroup and a second vector is divided into a second n-bit subgroup. A mask is applied to the first n-bit subgroup to generate a first masked vector and the mask is applied to the second n-bit subgroup to generate a second masked vector. The second masked vector is subtracted from the first masked vector to generate a result, and the generated result is outputted.

### BRIEF DESCRIPTION OF THE DRAWINGS

The present description will be better understood from the following detailed description read considering the accompanying drawings, wherein:

FIG. 1 is a block diagram illustrating an example system to optimize field programmable gate array (FPGA) resource utilization with digital signal processor (DSP) blocks to implement a DSP-based mask operator;

FIG. 2 is a block diagram illustrating an exemplary implementation of N-bits mask;

FIG. 3 is a block diagram illustrating an exemplary implementation of a 2-bits DSP-based mask;

FIG. 4 is a flowchart illustrating an example method for optimizing FPGA resource utilization with DSP blocks to implement a DSP-based mask operator; and

FIG. 5 illustrates an example computing apparatus as a functional block diagram.

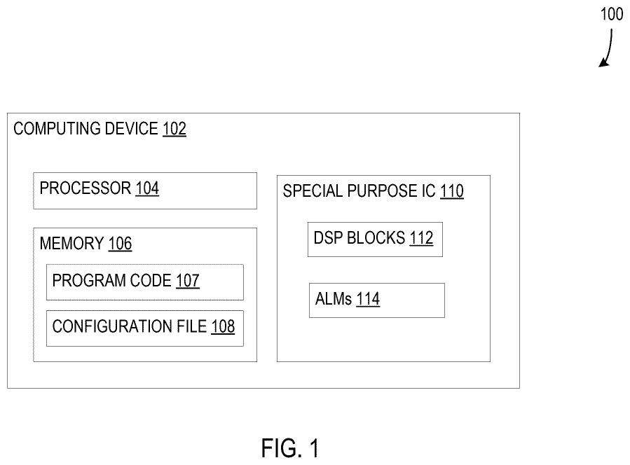

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Field programmable gate arrays (FPGAs) predominantly comprise units called adaptive logic modules (ALMs) and digital signal processors (DSPs). DSPs perform arithmetic operations (e.g., addition, subtraction, multiplication), making them suitable mainly for such applications. An operator in hardware design is a mask operator, which is traditionally implemented using lookup tables (LUTs) utilizing ALMs. A mask operator typically applies a bitwise operation to a set of data (e.g., AND, OR, XOR) to manipulate or extract certain bits. For example, masking is often used to clear, set, or isolate specific bits in data. Operations like AND, OR, XOR, and bit-shifting are inherently simple and generally implemented using ALMs. The LUTs within ALMs are ideal for these logic functions. Thus, most of the logic is implemented using ALMs. While the number of ALM may be quite large, it is still limited. In contrast, most non-DSP oriented designs (e.g., network packet processing) don't generally use DSPs. This results in excessive utilization of ALMs while the DSPs may be underutilized (or may even be idle sometimes).

Aspects of the disclosure optimize FPGA resource utilization by implementing a DSP-based mask operator. A first vector is divided into a first n-bit subgroup and a second vector is divided into a second n-bit subgroup. A mask is applied to the first n-bit subgroup to generate a first masked vector and the mask is applied to the second n-bit subgroup to generate a second masked vector. The second masked vector is subtracted from the first masked vector to generate a result and the generated result is outputted.

In some examples, some cloud computing providers may provide access to hardware instances (e.g., servers) that include connected FPGAs, thereby allowing users to customize the FPGAs to perform hardware acceleration of computational operations. Examples of the disclosure include systems and methods for accelerating the masking of data using hardware such as DSP blocks in the FPGA so that the load of overutilized ALM elements in the FPGA is redistributed to otherwise underutilized DSP blocks. One use case for FPGAs is the acceleration of computations that are associated with machine leaning tasks such as computer vision (e.g., image classification, instance segmentation, and the like), natural language processing (e.g., transformer models), and the like. Training a machine learning model, such as a deep neural network (DNN), may take hours of computing time for a small model and may take weeks or months of computing time for large models. Moving computationally expensive operations from programs running on relatively slow, general purpose processors (e.g., CPUs) or shaders running on graphics processing units (GPUs) onto FPGAs specifically configured to perform those expensive mathematical operations can provide significant reductions in total compute time and reductions in power consumption.

Aspects of the disclosure operate in an unconventional manner at least by utilizing the DSP blocks for implementing mask operator. The DSP blocks are optimized for high-speed arithmetic operations. Examples of the disclosure advantageously use the high-speed arithmetic operations capability of the DSP blocks to implement a mask operation that may be a part of a larger computation (e.g., in convolutional neural networks or signal processing pipelines). Examples of the disclosure implement the mask operator using DSPs, thereby alleviating the load on ALMs. By leveraging DSPs for the mask operator, the FPGA's efficiency is optimized, ensuring more effective utilization of FPGA resources and enhancing overall performance of the FPGA.

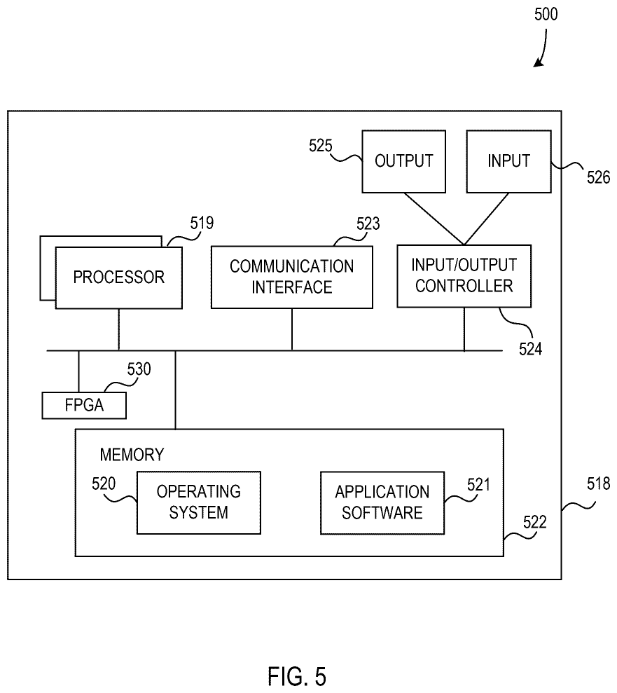

FIG. 1 is a block diagram illustrating an exemplary system 100 configured to optimize FPGA resource utilization with DSP blocks to implement a DSP-based mask operator. The system 100 includes a computing device 102 (e.g., the computing apparatus of FIG. 5) comprising a processor 104, and a memory 106 storing program code 107 that upon execution by the processor 104 use a configuration file 108 stored in the memory 106 to configure a special purpose integrated circuit (IC) 110. Special purpose IC 110 may comprise any type of integrated circuit programmed and/or designed to carry out certain types of tasks or operations. The special purpose IC 110 comprises DSP blocks 112 and ALMs 114. For example, the number of DSPs varies widely from tens to thousands of DSP blocks and the number of ALMs varies widely from thousands to hundred thousands of logic elements in an FPGA based on the specific FPGA model and manufacturer.

The special purpose IC 110 is an FPGA device, an application specific integrated circuit (ASIC), or other similar device that may comprise one or more processors to execute operations (e.g., instructions, computations, etc.) that is separate from the computing device 102. In other words, special purpose IC 110 may comprise appropriate circuitry to perform processing tasks for a host process that may be executing on an external processing unit, such as another computing device. In some examples, special purpose IC 110 may comprise a separate physical board or component that may be installed and/or housed within the computing device 102. In other examples, special purpose IC 110 may be located external to computing device 102 and be communicatively coupled to computing device 102, such as via USB, serial port, IEEE 1394, a network interface, or any other interface. The special purpose IC 110 (such as an FPGA device, ASIC device, or other similar processing device) may be programmed or designed for an intended purpose e.g., as a DSP-based mask operator upon configuration with the configuration file 108. The terms special purpose IC 110, FPGA, and ASIC are used interchangeably in this disclosure without deviating from the aspects of the disclosure.

In some examples, the configuration file 108 specifies a configuration of the FPGA (e.g., the special purpose IC 110) comprising DSP blocks 112 to implement a DSP-based mask operator. The DSP blocks 112 are configured to divide a first vector into a first n-bit subgroup and a second vector into a second n-bit subgroup. A mask is applied to the first n-bit subgroup to generate a first masked vector and the mask is applied to the second n-bit subgroup to generate a second masked vector. The second masked vector is subtracted from the first masked vector to generate a result and the generated result is outputted. In some examples, the DSP blocks 112 are further configured to divide the mask into a third n-bit subgroup.

In some examples, a value of n in the first n-bit subgroup, the second n-bit subgroup, and the third n-bit subgroup is two to implement a 2 bits DSP based mask. In some examples, the value of n may be more than two (e.g., 4, 16, 32, etc.) to implement the n-bits mask without deviating from the examples of the disclosure. However, implementing higher-bits mask (e.g., 4, 16, 32, etc.) may require the same or a greater number of DSP blocks than the number of DSP blocks required to implement a 2-bits mask.

Applying the mask to the first n-bit subgroup to generate the first masked vector comprises applying the third n-bit subgroup to the first n-bit subgroup to generate the first masked vector and applying the mask to the second n-bit subgroup to generate the second masked vector comprises applying the third n-bit subgroup to the second n-bit subgroup to generate the second masked vector. Applying the third n-bit subgroup to the first n-bit subgroup to generate the first masked vector is performed using a first group of two DSP blocks and applying the third n-bit subgroup to the second n-bit subgroup to generate the second masked vector is performed using a second group of two DSP blocks.

In some examples, the first group of two DSP blocks and the second group of two DSP blocks are different so that the mask operation for two different subgroups of 2-bits may be performed in parallel. In some examples, the first group of two DSP blocks and the second group of two DSP blocks are the same so that the mask operation for two different subgroups of 2-bits can be performed sequentially.

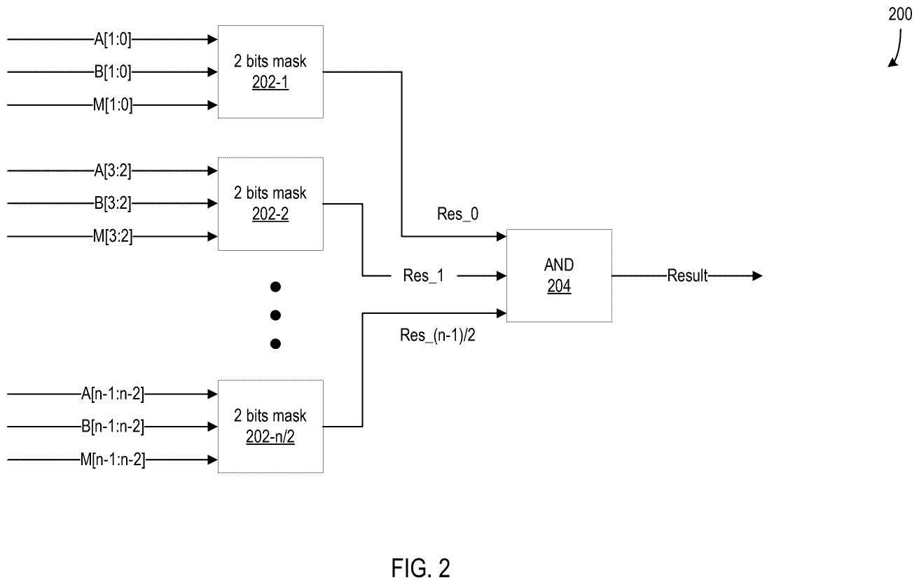

FIG. 2 is a block diagram 200 illustrating an exemplary implementation of N-bits mask. Let A, B, M be binary vectors of size N. Here, A and B are the operands that are to be evaluated to see if equal after applying the mask M they are equal i.e., if A&M=B&M. Where “&” is the bitwise and operator. Each natural K number can be represented as a polynomial:

$$K = {\sum }_{n = 0}^{∞} {k}_{n} {2}^{n}$$

Where kₙ∈[0,1]. For the N sized above vectors:

$$A = {\sum }_{n = 0}^{N - 1} {a}_{n} {2}^{n} , B = {\sum }_{n = 0}^{N - 1} {b}_{n} {2}^{n} , M = {\sum }_{n = 0}^{N - 1} {m}_{n} {2}^{n}$$

Where aₙ, bₙ, mₙ∈[0,1]. Using this notation, the mask check becomes:

$${\sum }_{n = 0}^{N - 1} {a}_{n} {m}_{n} {2}^{n} = {\sum }_{n = 0}^{N - 1} {b}_{n} {m}_{n} {2}^{n}$$

Alternatively, the mask check is represented as:

$${\sum }_{n = 0}^{N - 1} {a}_{n} {m}_{n} {2}^{n} - {\sum }_{n = 0}^{N - 1} {b}_{n} {m}_{n} {2}^{n} = 0$$

Which is equivalent to:

$$A \& M - B \& M = 0$$

To perform the mask operation between vectors A, B, and a mask M using DSP blocks, vectors A and B are divided into 2-bit subgroups. For example, the operation for N bits is divided into groups of 2 bits in the following way:

$${\sum }_{n = 0}^{N - 1} {a}_{n} {m}_{n} {2}^{n} = {\sum }_{n = 0}^{\frac{N}{2} - 1} {\sum }_{k = 0}^{1} {a}_{{2 n + k}_{}} {m}_{2 n + k} {2}^{2 n + k}$$

At this point, the focus is on the 2 bits bitwise operator, namely:

$${\sum }_{k = 0}^{1} {a}_{2 n + k} {m}_{2 n + k} {2}^{2 n + k} = {2}^{2 n} \cdot ( {a}_{2 n} {m}_{2 n} + {a}_{2 n + 1} {m}_{2 n + 1} \cdot 2 )$$

The goal is to represent the term in the parentheses using multiplications, additions, and subtractions so that these operations can be performed efficiently on DSP blocks which are optimized for such high-speed arithmetic operations. Now, multiplication of N bit vectors A and B would look as follows:

$$A \times M = {\sum }_{n = 0}^{N - 1} {\sum }_{k = 0}^{N - 1} {a}_{n} {m}_{k} {2}^{n + k}$$

When N=2:

$$A \times M = ( {a}_{0} + {a}_{1} \cdot 2 ) \times ( {m}_{0} + {m}_{1} \cdot 2 ) = {a}_{0} {m}_{0} + {a}_{1} {m}_{1} \cdot {2}^{2} + ( {a}_{0} {m}_{1} + {a}_{1} {m}_{0} ) \cdot 2$$

Where a₀ is the least significant bit (LSB) of vector A, a₁ is the next significant bit (or most significant bit (MSB) from 2-bits portion of vector A) of vector A. Herein, DSP terms equivalent to masked vectors are generated by first examining the product of two 2-bit vectors.

Alternatively,

$${a}_{0} {m}_{0} + {a}_{1} {m}_{1} \cdot {2}^{2} = A \times M - ( {a}_{0} {m}_{1} + {a}_{1} {m}_{0} ) \cdot 2$$

This result has two terms, one equivalent to a mask. The second term is subtracted from the product to get the mask-equivalent term for both vectors.

Note that a₀m₀, a₁m₁∈[0,1], which means that the calculation produces the following vector:

$$( {a}_{0} {m}_{0} , 0 , {a}_{1} {m}_{1} )$$

Recalling that bitwise and operator is:

$$A \& M = {\sum }_{n = 0}^{N - 1} {a}_{n} {m}_{n} {2}^{n}$$

And for N=2:

$$A \& M = {a}_{0} {m}_{0} + {a}_{1} {m}_{1} \cdot 2$$

Which corresponds to the vector:

$$A \& B = ( {a}_{0} {b}_{0} , {a}_{1} {b}_{1} )$$

As a result, checking whether A&M−B&M=0 is satisfied is equivalent to:

$$( A \times M - ( {a}_{0} {m}_{1} + {a}_{1} {m}_{0} ) \cdot 2 ) - ( B \times M - ( {b}_{0} {m}_{1} + {b}_{1} {m}_{0} ) \cdot 2 ) = 0$$

Herein, these mask-equivalent terms are subtracted to check if the result is 0. Rearranging this equation yields:

$$( A - B ) \times M + ( {b}_{0} - {a}_{0} ) \times 2 {m}_{1} + ( {b}_{1} - {a}_{1} ) \times 2 {m}_{0} = 0$$

In some examples, this equation is implemented using two DSPs working in the Fixed-Point Arithmetic 18×19 Mode. DSPs working in other modes (e.g., Fixed-point Arithmetic 9×9 Mode, Fixed-point Arithmetic 27×27 Mode, etc.) may be used to implement the mask operator, e.g., using more or fewer number of DSPs than the number of DSPs required in the Fixed-Point Arithmetic 18×19 Mode.

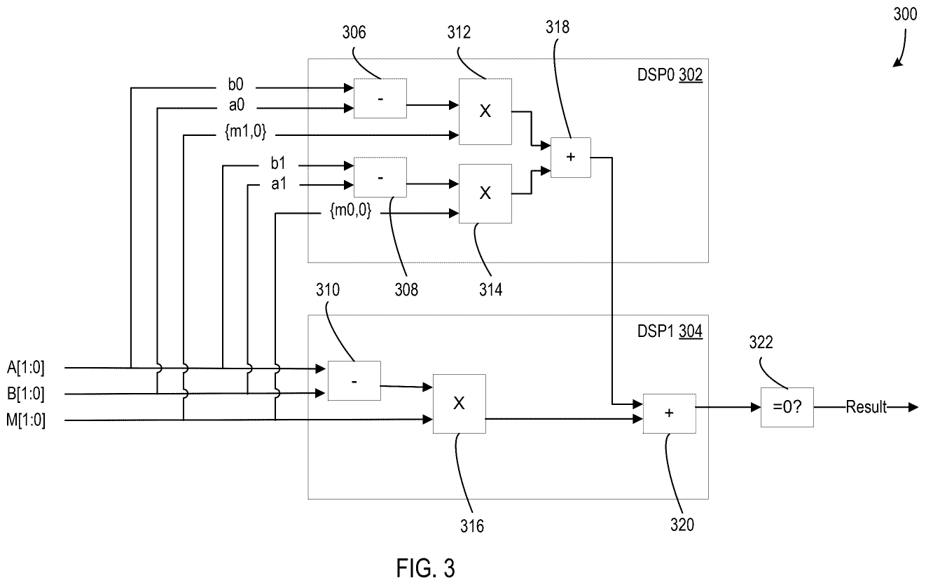

Referring again to FIG. 2, to perform the mask operation between vectors A, B, and a mask M using DSP blocks, vectors A and B are divided into 2-bits subgroups. For example, least significant two bits of vectors A, B, and mask M are inputted to a first 2 bits mask 202-1 (an exemplary implementation of 2 bits mask is illustrated in detail in FIG. 3). The next significant two bits of vectors A, B, and mask M are inputted to a second 2 bits mask 202-2 and so on. Similarly, the most significant two bits of vectors A, B, and mask M are inputted to a 2 bits mask 202-n/2. Thus, for checking whether vectors A and B of size n evaluate to A&M−B&M=0, n/2 number of 2 bits mask (such as 202-1 to 202-n/2) are required.

The first 2 bits mask 202-1 produces an output Res_0, the second 2 bits mask 202-2 produces an output Res_1, and the last 2 bits mask 202-n/2 produces an output Res_(n−1)/2 which are all provided as input to an and operator 204 to give a result. If the result is zero, the masked products of vectors A and B are determined to be the same.

FIG. 3 is a block diagram 300 illustrating an exemplary implementation of a 2-bits DSP-based mask such as the 2-bits masks 202-1 illustrated in FIG. 2. The least significant bits a0 and b0 from 2 bits divided subgroups from vectors A and B respectively are inputted to block 306 in first DSP block DSP0 302 for subtraction (e.g., to perform (b₀−a₀)) and the most significant bits a1 and b1 from 2 bits divided subgroups from vectors A and B respectively are inputted to block 308 in first DSP block DSP0 302 for subtraction (e.g., to perform (b₁−a₁)). Output from the block 306 and the mask are inputted to block 312 for multiplication (e.g., to result in (b₀−a₀)×2m₁) and the output from the block 308 and the mask are inputted to block 314 for multiplication (e.g., to result in (b₁−a₁)×2m₀). The outputs from the blocks 312 and 314 are inputted to perform arithmetic addition by block 318 (e.g., to result in (b₀−a₀)×2m₁+(b₁−a₁)×2m₀).

The 2-bits from the divided subgroups from vectors A and B are inputted to block 310 in the second DSP block DSP1 304 for subtraction (e.g., to perform (A−B)). The output from block 310 and the mask are inputted to block 316 for multiplication (e.g., to result in (A−B)×M). The outputs from block 318 in the first DSP block DSP0 302 and block 316 in the second DSP block DSP1 304 are inputted to block 320 in the second DSP block DSP1 304 for addition (to finally result in (A−B)×M+(b₀−a₀)×2m₁+(b₁−a₁)×2m₀). The output from block 320 is evaluated in block 322 to determine a result of the operation performed by the two DSP blocks 302 and 304 (e.g., to determine if (A−B)×M+(b₀−a₀)×2m₁+(b₁−a₁)×2m₀=0). This result is a part of the result of the mask operation similar to Res_0 represented in FIG. 2. Similarly, results Res_1 to Res_(n−1)/2 are determined using two DSP blocks that may be the same or different from the DSP blocks 302 and 304. These results Res_0, Res_1, . . . , Res_(n−a)/2 are inputted to block 204 to perform an and operation to output a result to determine whether A&M−B&M=0.

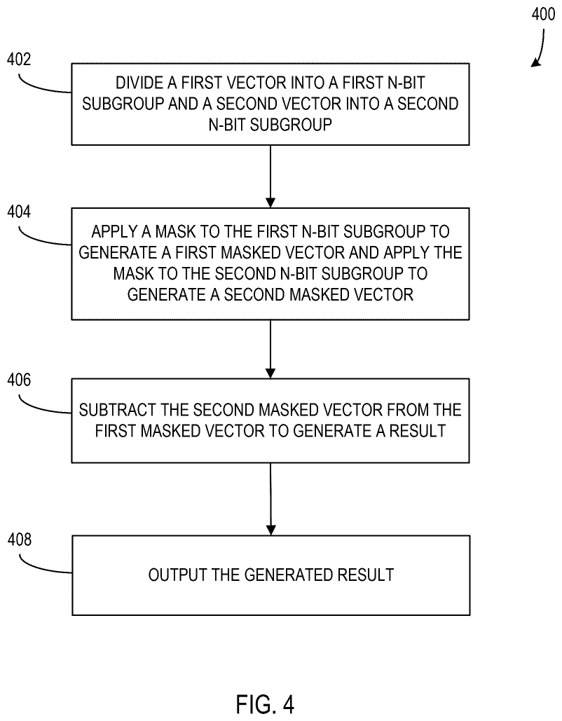

FIG. 4 is a flowchart illustrating an exemplary method 400 for optimizing FPGA resource utilization with DSP blocks to implement a DSP-based mask operator. In some examples, the method 400 is executed or otherwise performed in a system such as system 100 of FIG. 1. In some examples, the method 400 is executed or otherwise performed by DSP blocks 112 of a special purpose IC 110 as illustrated in FIG. 1.

At 402, a first vector is divided into a first n-bit subgroup and a second vector is divided into a second n-bit subgroup. At 404, a mask is applied by DSP blocks in a FPGA to the first n-bit subgroup to generate a first masked vector and the mask is applied by the DSP blocks in the FPGA to the second n-bit subgroup to generate a second masked vector. At 406, the second masked vector is subtracted from the first masked vector to generate a result. At 408, the generated result is outputted. If a value of the generated result is zero, the first masked vector and the second masked vector are determined to be the same. Otherwise, the first masked vector and the second masked vector are determined to be different. In some examples, the mask is divided into a third n-bit subgroup such that a value of n in the first n-bit subgroup, the second n-bit subgroup, and the third n-bit subgroup is two.

In some examples, the DSP blocks 112 in the FPGA 110 are configured by moving masking operations (e.g., operations 402-408) associated with a program running on a central processing unit (CPU) such as the processor 102 or a shader running on a graphics processing unit (GPU) (not shown) to the DSP blocks 112 in the FPGA 110. The masking operations are associated with one or more of a computer vision application, a natural language processing application, and training a machine learning model.

In some examples, applying the mask by the DSP blocks comprises redistributing applying the mask from ALMs in the FPGA to the DSP blocks in the FPGA. By this redistribution, examples of the disclosure advantageously shift the processing load from the overutilized ALMs to the DSP blocks which are underutilized in the FPGA resulting in the enhanced functionality of the FPGA. Applying the mask is associated with a machine learning task for computer vision (e.g., image classification, instance segmentation, and the like), natural language processing (e.g., transformer models), and the like. The machine learning task is broken down into sub-tasks and the sub-tasks that need to perform masking operation are performed by the DSP blocks.

In some examples, the configuration file 108 may include hardware description language (HDL) code corresponding to the FPGA 110. To configure special purpose IC 110 to perform a particular function, the source code that includes the instructions for performing the function may be translated into hardware-specific code corresponding to the type of hardware circuit that is going to be used. For example, if an FPGA is to be used to perform hardware acceleration, then the source code may be translated into HDL code corresponding to the FPGA (e.g., in the configuration file 108). Programming or configuring an FPGA with a configuration file sets the interconnects (or interconnect “fabric”) to configure the DSP blocks in a special way to implement a mask operator, thereby configuring the FPGA to perform the particular functionality specified by the configuration file (sometimes referred to as a “bit file”).

In some examples, FPGA 110 includes data paths configured to accelerate the computation of various mathematical functions including, but not limited to, masking data as described above with respect to FIGS. 1-3. For example, FPGA 110 may be configured to include other data paths for implementing other mathematical functions in accordance with examples of the present invention, such as computing a softmax function, an exponential function, a reciprocal square root function, and the like.

### Exemplary Operating Environment

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device.

In some examples, computing apparatus 518 comprises FPGA 530 (such as the special purpose IC 110 illustrated in FIG. 1) that comprises DSP blocks 112 and LLM elements 114. The FPGA 530 may be configured (using a configuration file or bit file) to implement data paths for accelerating mathematical operations, such as data paths to mask input data as described above according to various examples of the present disclosure. For example, optimization of FPGA resource utilization as described herein is performed with DSP-based mask operators implemented using the DSP blocks 112.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules, or configuration files (“bit files”) specifying the configuration of an FPGA to implement a particular functionality. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a field-programmable gate array (FPGA) comprising digital signal processor (DSP) blocks to implement a DSP-based mask operator, the DSP blocks configured to: divide a first vector into a first n-bit subgroup and a second vector into a second n-bit subgroup; apply a mask to the first n-bit subgroup to generate a first masked vector and apply the mask to the second n-bit subgroup to generate a second masked vector; subtract the second masked vector from the first masked vector to generate a result; and output the generated result.

An example method comprises dividing a first vector into a first n-bit subgroup and a second vector into a second n-bit subgroup; applying, by digital signal processor (DSP) blocks in a field-programmable gate array (FPGA), a mask to the first n-bit subgroup to generate a first masked vector and applying the mask to the second n-bit subgroup to generate a second masked vector; subtracting the second masked vector from the first masked vector to generate a result; and outputting the generated result.

An example special purpose integrated circuit (IC) comprising digital signal processor (DSP) blocks to implement a DSP-based mask operator, the DSP blocks configured to: divide a first vector into a first n-bit subgroup and a second vector into a second n-bit subgroup; apply a mask to the first n-bit subgroup to generate a first masked vector and apply the mask to the second n-bit subgroup to generate a second masked vector; compare the second masked vector with the first masked vector; and output a result of the comparison.

An example computer storage medium storing a configuration file, the configuration file specifying a configuration of a field programmable gate array (FPGA) comprising digital signal processor (DSP) blocks to implement a DSP-based mask operator, the configuration file configuring the DSP blocks to: divide a first vector into a first n-bit subgroup and a second vector into a second n-bit subgroup; apply a mask to the first n-bit subgroup to generate a first masked vector and apply the mask to the second n-bit subgroup to generate a second masked vector; subtract the second masked vector from the first masked vector to generate a result; and output the generated result.

Alternatively, or in addition to the other examples described herein, examples include any combination of the following:
wherein the DSP blocks in the FPGA are configured by moving masking operations associated with a program running on a central processing unit (CPU) or a shader running on a graphics processing unit (GPU) to the DSP blocks in the FPGA.
wherein the masking operations are associated with one or more of a computer vision application, a natural language processing application, and training a machine learning model.
wherein the DSP blocks are further configured to divide the mask into a third n-bit subgroup.
wherein a value of n in the first n-bit subgroup, the second n-bit subgroup, and the third n-bit subgroup is two.
wherein applying the mask to the first n-bit subgroup to generate the first masked vector comprises applying the third n-bit subgroup to the first n-bit subgroup to generate the first masked vector and applying the mask to the second n-bit subgroup to generate the second masked vector comprises applying the third n-bit subgroup to the second n-bit subgroup to generate the second masked vector.
wherein applying the third n-bit subgroup to the first n-bit subgroup to generate the first masked vector is performed using a first group of two DSP blocks and applying the third n-bit subgroup to the second n-bit subgroup to generate the second masked vector is performed using a second group of two DSP blocks.
wherein the first group of two DSP blocks and the second group of two DSP blocks are different or same.
wherein the DSP blocks in the FPGA are programmed with a configuration file to perform the dividing, the applying, the subtracting, and the outputting operations.
determining that the first masked vector and the second masked vector are the same based on a value of the generated result being zero; and determining that the first masked vector and the second masked vector are different based on a value of the generated result being non-zero.
wherein applying the mask comprises redistributing applying the mask from adaptive logic modules (ALMs) in the FPGA to the DSP blocks in the FPGA.
further comprising programming the DSP blocks in the FPGA with a configuration file to perform the applying the mask.
wherein applying the mask is associated with a machine learning task.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for creating a TI graph based on relationships in telemetry data obtained from a database, the TI graph comprising known entities and unknown entities; exemplary means for initializing risk scores for the known entities in the TI graph from a TI database; exemplary means for classifying, using a reputation propagation algorithm, one or more of the unknown entities based on relationships of the unknown entities with the known entities, and the risk scores for the known entities in the TI graph; exemplary means for recommending a remediation action for the classified unknown entities; exemplary means for automatically initiating the remediation action for the classified unknown entities; and exemplary means for updating the TI graph in response to the remediation action.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a field-programmable gate array (FPGA) comprising digital signal processor (DSP) blocks to implement a DSP-based mask operator, the DSP blocks configured to:
divide a first vector into a first n-bit subgroup and a second vector into a second n-bit subgroup;
apply a mask to the first n-bit subgroup to generate a first masked vector and apply the mask to the second n-bit subgroup to generate a second masked vector;
subtract the second masked vector from the first masked vector to generate a result; and
output the generated result.

2. The system of claim 1, wherein the DSP blocks in the FPGA are configured by moving masking operations associated with a program running on a central processing unit (CPU) or a shader running on a graphics processing unit (GPU) to the DSP blocks in the FPGA.

3. The system of claim 2, wherein the masking operations are associated with one or more of: a computer vision application, a natural language processing application, and training a machine learning model.

4. The system of claim 1, wherein the DSP blocks are further configured to divide the mask into a third n-bit subgroup, wherein a value of n in the first n-bit subgroup, the second n-bit subgroup, and the third n-bit subgroup is two, wherein applying the mask to the first n-bit subgroup to generate the first masked vector comprises applying the third n-bit subgroup to the first n-bit subgroup to generate the first masked vector and applying the mask to the second n-bit subgroup to generate the second masked vector comprises applying the third n-bit subgroup to the second n-bit subgroup to generate the second masked vector.

5. The system of claim 4, wherein applying the third n-bit subgroup to the first n-bit subgroup to generate the first masked vector is performed using a first group of two DSP blocks and applying the third n-bit subgroup to the second n-bit subgroup to generate the second masked vector is performed using a second group of two DSP blocks.

6. The system of claim 5, wherein the first group of two DSP blocks and the second group of two DSP blocks are different or same.

7. The system of claim 1, wherein the DSP blocks in the FPGA are programmed with a configuration file to perform the dividing, the applying, the subtracting, and the outputting operations.

8. A method comprising:
dividing a first vector into a first n-bit subgroup and a second vector into a second n-bit subgroup;
applying, by digital signal processor (DSP) blocks in a field-programmable gate array (FPGA), a mask to the first n-bit subgroup to generate a first masked vector and applying the mask to the second n-bit subgroup to generate a second masked vector;
subtracting the second masked vector from the first masked vector to generate a result; and
outputting the generated result.

9. The method of claim 8, further comprising dividing the mask into a third n-bit subgroup, wherein a value of n in the first n-bit subgroup, the second n-bit subgroup, and the third n-bit subgroup is two.

10. The method of claim 9, wherein applying the mask to the first n-bit subgroup to generate the first masked vector comprises applying the third n-bit subgroup to the first n-bit subgroup to generate the first masked vector and applying the mask to the second n-bit subgroup to generate the second masked vector comprises applying the third n-bit subgroup to the second n-bit subgroup to generate the second masked vector.

11. The method of claim 10, wherein applying the third n-bit subgroup to the first n-bit subgroup to generate the first masked vector is performed using a first group of two DSP blocks and applying the third n-bit subgroup to the second n-bit subgroup to generate the second masked vector is performed using a second group of two DSP blocks.

12. The method of claim 11, wherein the first group of two DSP blocks and the second group of two DSP blocks are different or same.

13. The method of claim 8, further comprising programming the DSP blocks in the FPGA with a configuration file to perform the applying the mask.

14. The method of claim 8, wherein applying the mask is associated with a machine learning task.

15. The method of claim 8, further comprising:
determining that the first masked vector and the second masked vector are the same based on a value of the generated result being zero; and
determining that the first masked vector and the second masked vector are different based on a value of the generated result being non-zero.

16. A special purpose integrated circuit (IC) comprising digital signal processor (DSP) blocks to implement a DSP-based mask operator, the DSP blocks configured to:
divide a first vector into a first n-bit subgroup and a second vector into a second n-bit subgroup;
apply a mask to the first n-bit subgroup to generate a first masked vector and apply the mask to the second n-bit subgroup to generate a second masked vector;
compare the second masked vector with the first masked vector; and
output a result of the comparison.

17. The special purpose IC of claim 16, wherein the DSP blocks are further configured to divide the mask into a third n-bit subgroup.

18. The special purpose IC of claim 17, wherein a value of n in the first n-bit subgroup, the second n-bit subgroup, and the third n-bit subgroup is two.

19. The special purpose IC of claim 18, wherein applying the mask to the first n-bit subgroup to generate the first masked vector comprises applying the third n-bit subgroup to the first n-bit subgroup to generate the first masked vector and applying the mask to the second n-bit subgroup to generate the second masked vector comprises applying the third n-bit subgroup to the second n-bit subgroup to generate the second masked vector.

20. The special purpose IC of claim 19, wherein applying the third n-bit subgroup to the first n-bit subgroup to generate the first masked vector is performed using a first group of two DSP blocks and applying the third n-bit subgroup to the second n-bit subgroup to generate the second masked vector is performed using a second group of two DSP blocks.
